(19) United States
(12) Patent Application Publication
(10) Pub. No.: US 2007/0257615 A1
(43) Pub. Date: Nov. 8, 2007

(54) Plasma display panel

(76) Inventors: Hyun Soh, Suwon-si (KR); Se-Jong Kim, Suwon-si (KR); Yun-Hee Kim, Suwon-si (KR); Hyun Kim, Sunwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/789,375

(22) Filed: Apr. 23, 2007

(30) Foreign Application Priority Data
Apr. 25, 2006 (KR) 10-2006-0037212

(51) Int. Cl. H01J 17/49

(52) U.S. Cl. 313/582

(57) ABSTRACT

Provided is a plasma display panel which is capable of achieving high-efficiency. The plasma display panel includes: a front substrate; a rear substrate opposite to the front substrate; a plurality of barrier ribs defining a plurality of discharge cells in a space between the front substrate and the rear substrate; a plurality of sustain electrodes extended along the front substrate and arranged in pairs, wherein each sustain electrode pair consists of a pair of an X electrode and a Y electrode that are opposite to each other and generate a discharge; a plurality of address electrodes extended along the rear substrate, and intersecting the sustain electrodes at parts corresponding to the discharge cells; and a light-emitting material formed in the discharge cells and emitting red, green and blue visible light, wherein a ratio of an electrode gap with respect to a cell pitch is between 0.2 and 0.4, wherein the electrode gap is a distance between the X electrode and the Y electrode and the cell pitch is a distance between two adjacent barrier ribs defining each discharge cell.

### CROSS-REFERENCE TO RELATED PATENT APPLICATION

This application claims the benefit of Korean Patent Application No. 10-2006-0037212, filed on Apr. 25, 2006, in the Korean Intellectual Property Office, the disclosure of which is incorporated herein in its entirety by reference.

### BACKGROUND OF THE INVENTION

1. Field of the Invention

The present embodiments relate to a plasma display panel and a manufacturing method thereof, and more particularly, to a plasma display panel which is capable of achieving high efficiency by maximizing efficiency of a plasma display panel, and a manufacturing method thereof.

1. Description of the Related Art

Plasma display panels, which display images using a gas discharge phenomenon, are excellent in view of display capacity, brightness, contrast, afterimage, viewing angle, etc. For this reason, recently, plasma display panels are noted as devices that can substitute for cathode ray tubes (CRTs). In a plasma display panel, a discharge is generated in a gas filled between electrodes, by a DC or AC voltage applied to the electrodes, and phosphors are excited due to an ultraviolet discharge caused by the discharge, thereby emitting light.

In a conventional plasma display panel, sustain electrode pairs, each sustain electrode pair being a pair of an X display electrode and a Y display electrode which are transparent electrodes, are formed in the internal surface of a front glass substrate, and address electrodes are formed in the internal surface of a rear glass substrate. A sustain discharge is generated between X display electrodes and Y display electrodes when the plasma display panel operates.

Meanwhile, a plurality of barrier ribs are formed on the rear glass substrate, and a plurality of cells are defined by the barrier ribs.

The operation of the plasma display panel having the construction described above will be schematically described below. First, a high trigger voltage is applied so that a discharge is generated between the address electrodes and at least one of the display electrodes. By use of the trigger voltage, a discharge is generated in predetermined cells. If the trigger voltage exceeds a threshold voltage, the discharge occurs and, a discharge gas filled in the cells becomes a plasma, so that a stable sustain discharge state can be maintained between the X display electrodes and the Y display electrodes. In the sustain discharge state, ultraviolet light among discharge light collides with phosphors in the cells, thereby emitting light, and accordingly, respective pixels corresponding to the respective cells display an image.

When a plasma display panel is designed, factors, such as brightness, margin, cross-talk, etc., must be considered, and efficiency of the panel is also important. The efficiency of the panel can be defined as a brightness value with respect to input energy. A panel which can obtain high brightness with a low energy input is a high efficiency panel.

In a conventional technique, an electrode gap G is maintained between 70 and 100 μm for sustain voltage driving. The electrode gap G is the distance between an X display electrode and a Y display electrode that are sustain electrodes. The sustain electrodes are located in cell discharge areas, over the barrier ribs. Generally, the lower plate can have a stripe pattern, a matrix pattern, etc.

The conventional plasma display panel can be easily manufactured but has light-emitting efficiency less than 2 lm/W. Conventionally, VGA (640×480) and SVGA (800×600) plasma display panels have been mainly manufactured, however, there is a need to develop high definition panels (1920×1035) for HDTV. Accordingly, high-efficiency panels are required. The instant embodiments address this requirement and others as well.

### SUMMARY OF THE INVENTION

The present embodiments provide a plasma display panel which is capable of achieving high-efficiency by limiting a ratio of an electrode gap with respect to a cell pitch.

According to an aspect of the present embodiments, there is provided a plasma display panel including: a front substrate; a rear substrate opposite to the front substrate; a plurality of barrier ribs defining a plurality of discharge cells in a space between the front substrate and the rear substrate; a plurality of sustain electrodes extended along the front substrate and arranged in pairs, wherein each sustain electrode pair consists of a pair of an X electrode and a Y electrode that are opposite to each other and generate a discharge; a plurality of address electrodes extended along the rear substrate, and intersecting the sustain electrodes at parts corresponding to the discharge cells; and a light-emitting material formed in the discharge cells and emitting red, green and blue visible light, wherein a ratio of an electrode gap with respect to a cell pitch is between about 0.2 and about 0.4, wherein the electrode gap is a distance between the X electrode and the Y electrode and the cell pitch is a distance between two adjacent barrier ribs defining each discharge cell.

The electrode gap is preferably larger than about 120 μm.

A width of the electrode gap is greater than a height of each barrier rib.

The plasma display panel further includes a plurality of bus electrodes formed on the sustain electrodes, along the sustain electrodes, wherein a width of each bus electrode is narrower than a width of each sustain electrode.

The plasma display panel further includes a first dielectric layer formed on the rear substrate and covering the address electrodes, and a second dielectric layer formed on the front substrate and covering the sustain electrodes.

The plasma display panel further includes a protection film applied to the second dielectric layer formed on the front substrate.

The cell pitch P is defined as a distance between two adjacent barrier ribs in a discharge cell, and the electrode gap G is defined as a distance between transparent sustain electrodes located over a discharge cell.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a plasma display panel according to an embodiment;

FIG. 2 illustrates a cell pitch P and an electrode gap G on a front substrate of the plasma display panel illustrated in FIG. 1;

FIG. 3 is a cross-sectional view of the plasma display panel illustrated in FIG. 1;

FIGS. 4A and 4B illustrate discharge simulation results when the cell pitch P of the plasma display panel illustrated in FIG. 3 is 640 μm and the electrode gap G of the plasma display panel is 80 μm and 180 μm, respectively;

FIG. 5 is a graph showing an efficiency enhancement range with respect to the ratio G/P of the electrode gap G with respect to the cell pitch P of the plasma display panel illustrated in FIG. 3;

FIG. 6A illustrates discharge simulation results in a cell with respect to time, in a conventional plasma display panel, and FIG. 6B illustrates discharge simulation results in a cell with respect to time, in the plasma display panel according to the present embodiments; and

FIGS. 7A, 7B and 7C are views illustrating voltage transfer closed curves, with respect to the ratio G/P of the electrode gap G with respect to the cell pitch P of the plasma display panel illustrated in FIG. 3.

### DETAILED DESCRIPTION OF THE INVENTION

Hereinafter, an embodiment will be described in detail with reference to the appended drawings.

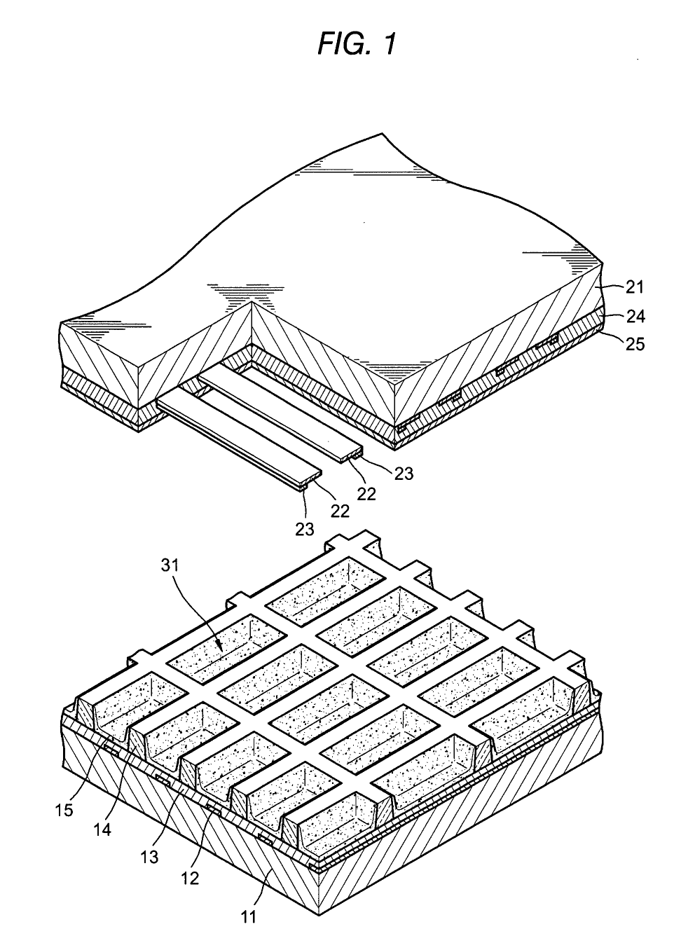

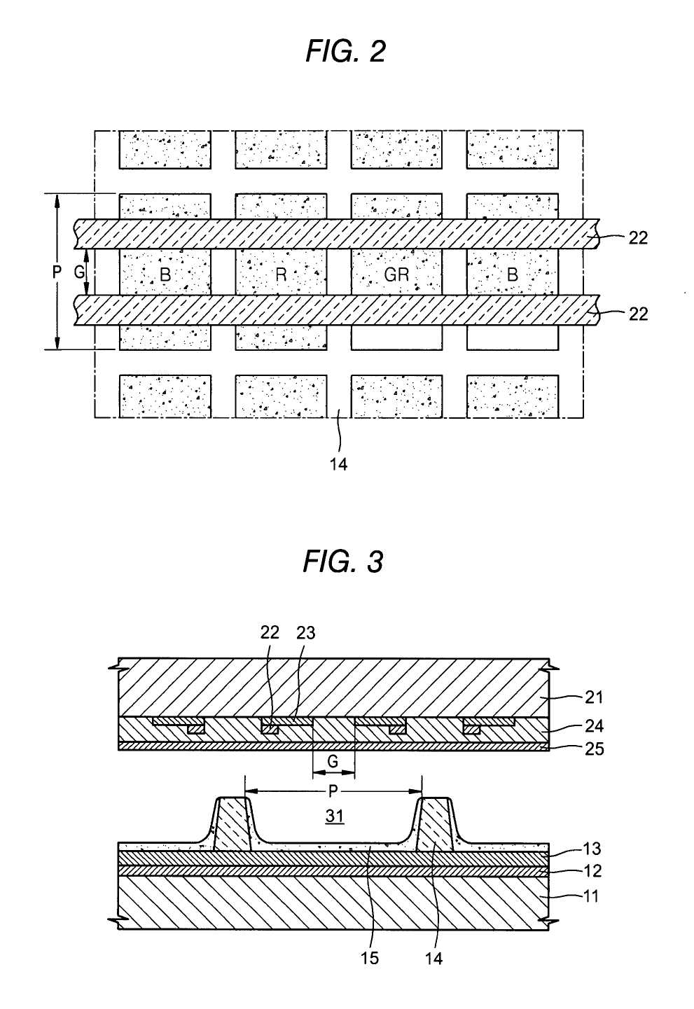

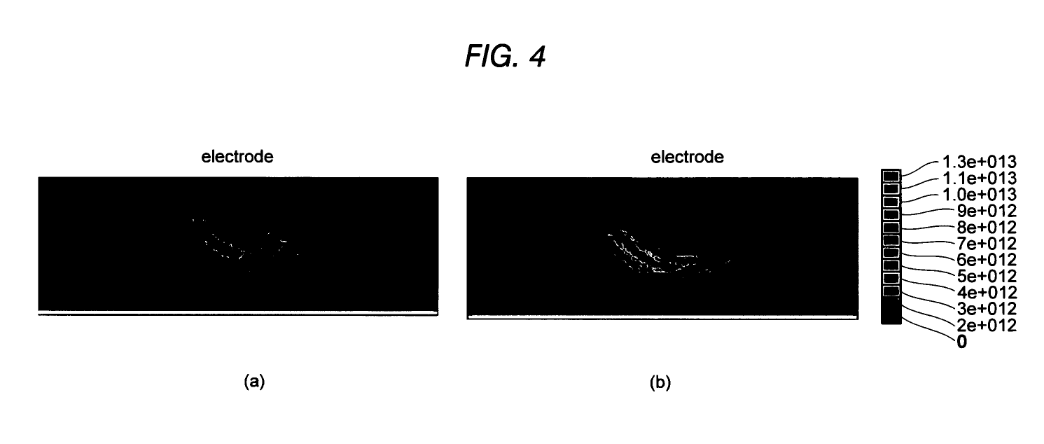

FIG. 1 is an exploded perspective view of a plasma display panel according to an embodiment, FIG. 2 illustrates a cell pitch P and an electrode gap G on a front substrate of the plasma display panel illustrated in FIG. 1, and FIG. 3 is a cross-sectional view of the plasma display panel illustrated in FIG. 1.

Referring to FIGS. 1, 2 and 3, the plasma display panel includes a rear substrate 11, a plurality of address electrodes 12 arranged in a predetermined pattern on the upper surface of the rear substrate 11, and a first dielectric layer 13 which covers the address electrodes 12 on the rear substrate 11.

The rear substrate 11 is coupled with a transparent front substrate 21, thus forming a discharge space. On the lower surface of the front substrate 21 opposite to the rear substrate 11, a plurality of sustain electrodes, which are arranged in pairs, are formed in a manner to intersect the address electrodes 12, wherein each sustain electrode pair consists of a pair of an X display electrode and a Y display electrode. Referring to FIG. 2, an electrode gap G is a distance between the X display electrode and the Y display electrode, and can be adjusted considering a discharge start voltage or the number of pixels, etc. The sustain electrodes 22, which consist of the X and Y display electrode pairs, can be made of a transparent material, such as indium titanium oxide (ITO). On the X and Y display electrodes, a plurality of bus electrodes 23 are respectively disposed along the respective X and Y display electrodes. The bus electrodes 23 are used to prevent line resistance from increasing as the lengths of the sustain electrodes 22 increase. The bus electrodes 23 are made of metal, such as silver, silver alloy, aluminum, etc. The widths of the bus electrodes 23 are narrower than the widths of the X and Y display electrodes.

A second dielectric layer 24 is formed to cover the sustain electrodes 22 and the bus electrodes 23, over the front substrate 21.

A protection film 25 can be formed on the second dielectric layer 24. The protection film 25 can be made of a material such as MgO, and used to protect the sustain electrodes 22, the bus electrodes 23 and the second dielectric layer 24 and accelerate emission of secondary electrons while a discharge occurs, thus facilitating the discharge.

As described above, a plurality of barrier ribs 14 that define discharge cells are formed between the rear substrate 11 on which the first dielectric layer 13 is formed and the front substrate 21 on which the second dielectric layer 24 is formed. The barrier ribs 14 are arranged in parallel to the address electrodes 12, between the address electrodes 12, and are formed on the upper surface of the first dielectric layer 13.

The width of each bus electrode 23 can be greater than the width of each barrier rib 14. An inert gas, such as Ne and Xe, is filled in cells 31 defined by the barrier ribs 14. Also, phosphors 15 are formed on the inner surfaces of the barrier ribs 14 that define the respective cells 31, respectively.

The phosphors 15 have red, green and blue colors. In the plasma display panel, pixels are formed by the cells 31 defined by the barrier ribs 14, and the red, green and blue phosphors 15 formed on the cells 31. A pair of transparent display electrodes is disposed over each cell 31. Also, each pixel consists of three sub pixels of red, green and blue.

In the plasma display panel, the cells 31 have a predetermined cell pitch P, and the cell pitch P depends on a design specification of a plasma display apparatus.

According to the present embodiments, the cell pitch P and an electrode gap G are set so that a ratio G/P of the electrode gap G with respect to the cell pitch P is between about 0.2 and about 0.4.

Examples of some combinations of cell pitches P and electrode gaps G that satisfy a ratio G/P of about 0.2 through about 0.4 are listed in the following table.

| Cell Pitch | Ratio G/P of Electrode Gap and Cell Pitch | | | | |
|---|---|---|---|---|---|
| (μm) | 0.2 | 0.25 | 0.3 | 0.35 | 0.4 |
| 480 | 96 | 120 | 144 | 168 | 192 |
| 570 | 114 | 142.5 | 171 | 199.5 | 228 |
| 640 | 128 | 160 | 192 | 224 | 256 |
| 800 | 160 | 200 | 240 | 280 | 320 |

The plasma display panel having the structure described above activates diffusion in discharge cells, rather than a conventional technique having an electrode gap of 70 through 100 μm, and accordingly, maximizes vacuum ultraviolet (VUV) light generation due to excitation of an Xe gas, thereby increasing light-emitting brightness.

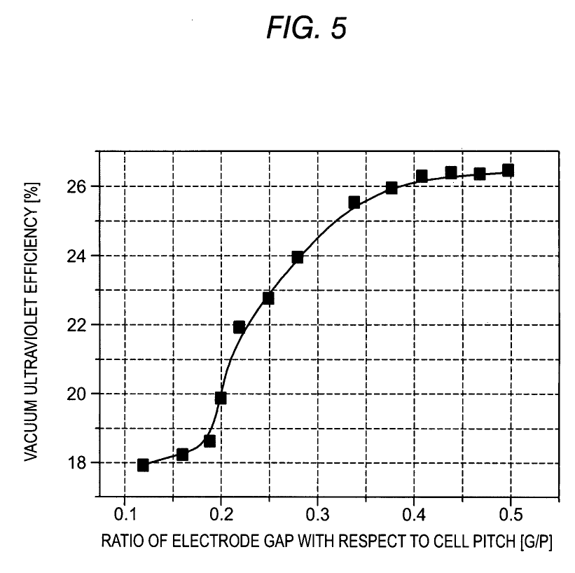

FIGS. 4A and 4B illustrate discharge simulation results when the cell pitch P of the plasma display panel illustrated in FIG. 3 is 640 μm and the electrode gap G of the plasma display panel is 80 μm and 180 μm, respectively. Referring to FIGS. 4A and 4B, brightness greatly increases with respect to discharge diffusion when the electrode gap G is 180 μm. The brightness increase with respect to discharge diffusion is effective when a gap G between transparent electrodes is larger than about 120 μm.

If the electrode gap (G) value is larger than a predetermined portion or smaller than a predetermined portion in a cell area, it is difficult to easily generate a efficient discharge between electrodes. If the ratio G/P of the electrode gap G with respect to the cell pitch P is smaller than about 0.2, a stable discharge is ensured, however, since the density of electrons becomes very high in the center part of each cell, light-emitting efficiency cannot be maximized. Meanwhile, if the ratio G/P is larger than about 0.4, a discharge voltage sharply increases, so that a discharge start voltage and a sustain voltage cannot satisfy a general driving condition of the plasma display panel.

An area which can induce a discharge in a general structure and in which plasma discharge diffusion increases light-efficiency is important. The area depends on an electrode structure of a front plate and a discharge space. When the ratio of G/P is between about 0.2 and about 0.4, discharge diffusion is enhanced, which increases efficiency of the plasma display panel.

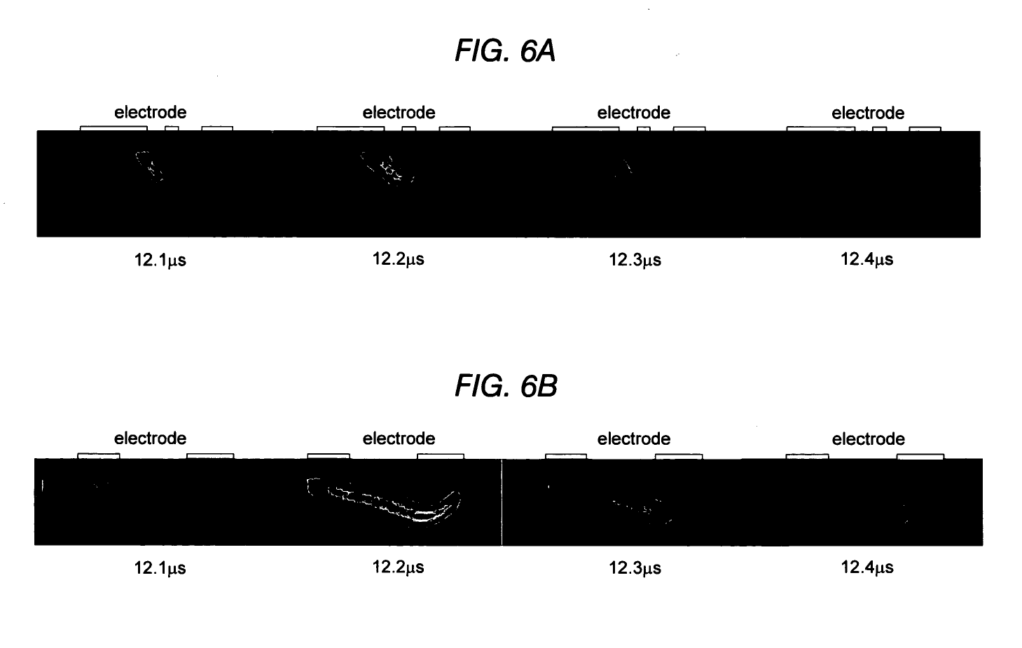

FIG. 5 is a graph showing a vacuum ultraviolet (VUV) transform efficiency enhancement range of an Xe gas, with respect to the ratio G/P of the electrode gap G to the cell pitch P of the plasma display panel. FIG. 5 shows that a VUV transform efficiency value increases as the electrode gap G increases.

The cell pitch P is an important factor for defining the discharge space, and the electrode gap G is an important factor for defining the area of electrodes located over each cell. As the electrode gap G increases, the discharge start voltage increases and light-efficiency can be enhanced due to the increase of a discharge path. However, if the electrode area decreases, capacitance is reduced and accordingly, light-efficiency can be enhanced. Referring to FIG. 5, by setting the cell pitch P and the electrode gap G so that the ratio (G/P) value is larger than about 0.2, the efficiency of the plasma display panel can be enhanced.

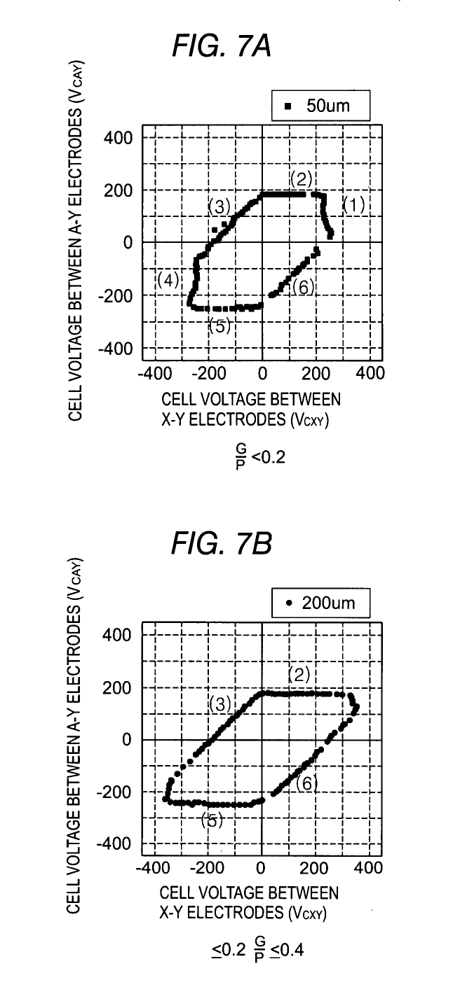

FIG. 6A illustrates discharge simulation results in a cell with respect to time, in a conventional plasma display panel, and FIG. 6B illustrates discharge simulation results in a cell with respect to time, in the plasma display panel according to the present embodiments.

Referring to FIG. 6A, in the conventional plasma display panel, a discharge is started in X electrodes in 12.1 μs, the discharge is diffused to Y electrodes and then a cathode fall occurs in 12.2 μs, the discharge is extended to the edges of the electrodes in 12.3 μs, and the discharge is extinguished in 12.4 μs.

Referring to FIG. 6B, in the plasma display panel according to the current embodiment, the ratio G/P is between about 0.2 and about 0.4. In this case, a discharge is started in X electrodes in 12.1 μs, an X-Y long gap discharge is strengthened in 12.2 μs, a discharge diffusion area is widely formed in 12.3 μs, and the discharge is weakened in 12.4 μs.

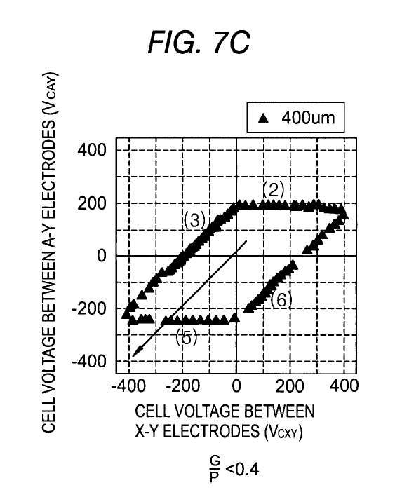

FIGS. 7A, 7B and 7C are views illustrating voltage transfer (Vt) closed curves, with respect to the ratio G/P of the electrode gap G with respect to the cell pitch P of the plasma display panel. The Vt closed curve is a group of points plotting cell voltages at which a small discharge is started, on a cell voltage plane in which a cell voltage between address (A) electrodes and Y display electrodes with respect to a cell voltage between X display electrodes and Y display electrodes is represented in an orthogonal coordinates system. FIG. 7A corresponds to a case when the ratio G/P is smaller than 0.2, FIG. 7B corresponds to a case when the ratio G/P is between 0.2 and 0.4, and FIG. 7C corresponds to a case when the ratio G/P is larger than 0.4. In FIGS. 7A, 7B and 7C, a horizontal part (2) of the Vt closed curve in a first quadrant relates to a discharge between the A-Y electrodes, and a vertical part (1) of the Vt closed curve in the first quadrant relates to a discharge between the X-Y electrodes. As the length of the vertical part (1) decreases, a discharge margin is reduced. The horizontal part (2) shows a discharge area between the A-Y electrodes. As the length of the horizontal part (2) increases, since an opposite discharge increases rather than a sustain discharge, a wrong discharge occurs. In FIG. 7C, a vertical part (1) almost does not exist and the length of the horizontal part (2) is long. That is, when the vertical part (1) almost does not exist, a discharge margin is greatly reduced.

Accordingly, since a discharge margin decreases if the ratio G/P exceeds about 0.4, the electrode gap G and cell pitch P of the plasma display panel are set so that the ratio G/P is smaller than about 0.4.

Another difference between the present embodiments and the conventional structure is in that the width of an electrode gap is greater than the height of a barrier rib. The structure according to the present embodiments considers that a discharge is generated between front and rear substrates as well as between sustain electrodes, when the discharge is generated in discharge cells.

In a plasma display panel according to the present embodiments, by limiting the ratio of an electrode gap with respect to a cell pitch to a predetermined range, high-efficiency can be achieved.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a front substrate;
a rear substrate opposite to the front substrate;
a plurality of barrier ribs defining a plurality of discharge cells in a space between the front substrate and the rear substrate;
a plurality of sustain electrodes extended along the front substrate and arranged in pairs, wherein each sustain electrode pair consists of a pair of an X electrode and a Y electrode that are opposite to each other and are configured to generate a discharge;
a plurality of address electrodes extended along the rear substrate, and intersecting the sustain electrodes at points corresponding to the discharge cells; and
a light-emitting material formed in the discharge cells and configured to emit red, green and blue visible light,
wherein the ratio of the electrode gap with respect to the cell pitch is from about 0.2 to about 0.4, wherein the electrode gap is a distance between the X electrode and the Y electrode and the cell pitch is a distance between two adjacent barrier ribs defining each discharge cell.

2. The plasma display panel of claim 1, wherein the electrode gap is larger than about 120 μm.

3. The plasma display panel of claim 1, wherein the cell pitch is selected from 480, 570, 640 and 800.

4. The plasma display panel of claim 1, wherein the electrode gap is selected from the group consisting of 96, 120, 144, 168, 192, 114, 142.5, 171, 199.5, 228, 128, 160, 192, 224, 256, 160, 200, 240, 280 and 320.

5. The plasma display panel of claim 1, wherein the width of the electrode gap is greater than the height of each barrier rib.

6. The plasma display panel of claim 1, wherein the ratio of the electrode gap with respect to the cell pitch is about 0.2.

7. The plasma display panel of claim 1, wherein the ratio of the electrode gap with respect to the cell pitch is about 0.25.

8. The plasma display panel of claim 1, wherein the ratio of the electrode gap with respect to the cell pitch is about 0.3.

9. The plasma display panel of claim 1, wherein the ratio of the electrode gap with respect to the cell pitch is about 0.35.

10. The plasma display panel of claim 1, wherein the ratio of the electrode gap with respect to the cell pitch is about 0.4.

11. The plasma display panel of claim 1, further comprising a plurality of bus electrodes formed on the sustain electrodes, wherein the width of each bus electrode is narrower than the width of each sustain electrode.

12. The plasma display panel of claim 1, further comprising a first dielectric layer formed on the rear substrate and covering the address electrodes, and a second dielectric layer formed on the front substrate and covering the sustain electrodes.

13. The plasma display panel of claim 11, further comprising a protection film applied to the second dielectric layer formed on the front substrate.

14. The plasma display panel of claim 13, wherein the cell pitch is selected from 480, 570, 640 and 800.

15. The plasma display panel of claim 13, wherein the electrode gap is selected from the group consisting of 96, 120, 144, 168, 192, 114, 142.5, 171, 199.5, 228, 128, 160, 192, 224, 256, 160, 200, 240, 280 and 320.

16. The plasma display panel of claim 13, wherein the ratio of the electrode gap with respect to the cell pitch is about 0.2.

17. The plasma display panel of claim 13, wherein the ratio of the electrode gap with respect to the cell pitch is about 0.25.

18. The plasma display panel of claim 13, wherein the ratio of the electrode gap with respect to the cell pitch is about 0.3.

19. The plasma display panel of claim 13, wherein the ratio of the electrode gap with respect to the cell pitch is about 0.35.

20. The plasma display panel of claim 13, wherein the ratio of the electrode gap with respect to the cell pitch is about 0.4.
